(19) United States
(12) Patent Application Publication
(10) Pub. No.: US 2008/0168453 A1
(43) Pub. Date: Jul. 10, 2008

(54) WORK PRIORITIZATION SYSTEM AND METHOD

(75) Inventors: James O. Hutson, Chillicothe, IL (US); Gram M. Ludlow, Morton, IL (US); Todd M. Wagner, Washington, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/970,577

(22) Filed: Jan. 8, 2008

Related U.S. Application Data
(60) Provisional application No. 60/884,071, filed on Jan. 9, 2007.

(51) Int. Cl. G06F 9/46

(52) U.S. Cl. 718/103

(57) ABSTRACT

A work prioritization system and method that includes determining a task false positive rate for the work task. The work prioritization system and method may further include determining an event materiality score based on the task false positive rate and prioritizing the work task within the plurality of work tasks based on the event materiality score.

### CROSS-REFERENCE RELATED APPLICATIONS

This application claims the benefit of U.S. Provisional Application No. 60/884,071, filed Jan. 9, 2007.

### TECHNICAL FIELD

This invention relates generally to a system and method for prioritizing the allocation of resources and more specifically, work prioritization.

### BACKGROUND

Several types of software may be used to identify improper behavior within an organization and between the organization and others. For example, monitoring and security software may look for keywords, formats, and other sequences in electronic documents and communication in order to identify an incident, such as potentially improper behavior. Each keyword, format, sequence or other search function may be a software policy that is used by the software to trigger the software to record information associated with an incident into a log for further review by a security team, manager, human resource person, or other individual with the authority to operate the software within the organization. In other words, each incident may be a work task that may be resolved through further investigation.

Each policy may identify a large number of incidents each day and record each incident in a database for further review and investigation. Once an incident is reviewed, the incident may be determined to be a false positive. In other words, the identified incident is determined to not be an incident and may instead be a normal operation of the organizations systems. Each false positive investigation may be time consuming and costly to the organization without providing benefit to the organization.

The present invention is directed to overcome one or more of the problems as set forth above.

### SUMMARY OF THE INVENTION

In one example of the present invention, a system for prioritizing a plurality of work tasks is provided. The system may include a computer readable medium storing instructions, a processor for implementing the instructions, and an output device for providing a prioritized list of the plurality of work tasks.

The instructions may include determining a task false positive rate for each of the plurality of work tasks. The instructions may also include determining an event materiality score for each of the plurality of work tasks based on the task false positive rate and prioritizing the plurality of work tasks according to the event materiality score.

Alternatively, a method for prioritizing a work task within a plurality of work tasks may include determining a task false positive rate for the work task and determining a risk value for the work task. Further, the method may include determining an event materiality score based on the task false positive rate and the risk value, and prioritizing the work task within the plurality of work tasks according to the event materiality score.

In another configuration, a method may be used to prioritize an investigation of an incident. The method may include implementing a security policy and receiving an incident notification based on an incident associated with a violation of the security policy. Additionally, a policy false positive rate for the security policy and a risk value for the incident notification may be determined. Further, the method may include determining an event materiality score for the incident notification based on the policy false positive rate and the risk value and prioritizing the investigation of the incident notification according to the event materiality score.

### BRIEF DESCRIPTION OF THE DRAWINGS

FIG. 1 is a block diagram of a system according to the present disclosure within an electronic communication infrastructure.

FIG. 2 illustrates a prioritized list of work tasks.

### DETAILED DESCRIPTION

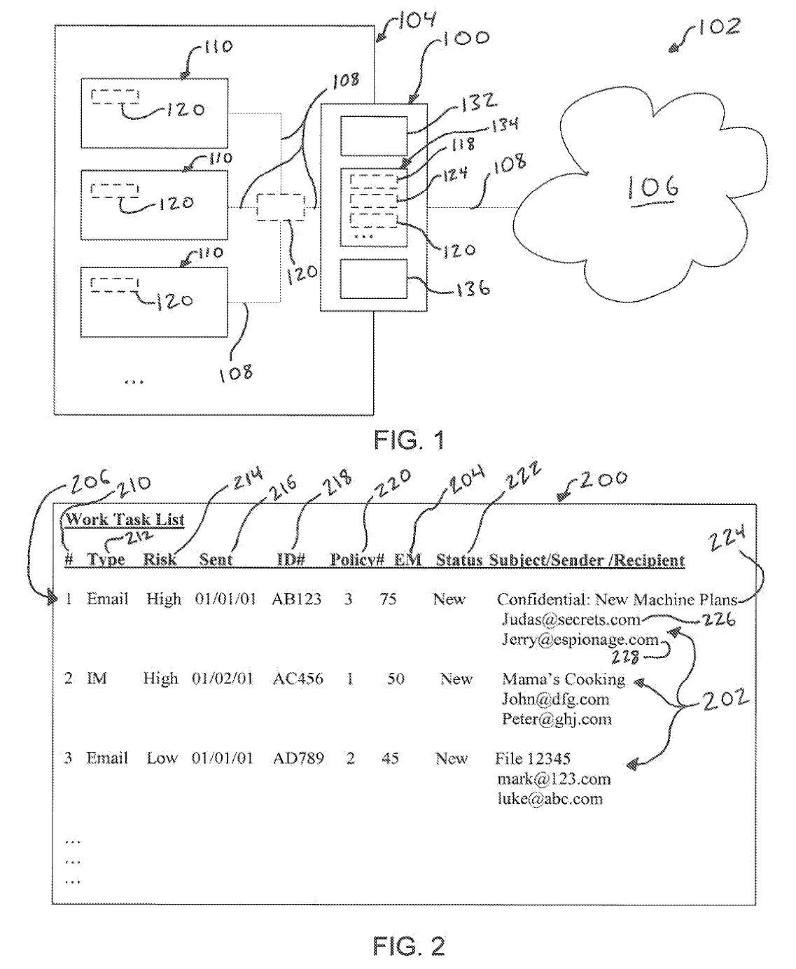

Referring to FIG. 1, a block diagram illustrates a system 100 within an electronic communication infrastructure 102 that may be configured to provide work prioritization. The electronic communication infrastructure 102 may include a network 104, such as a private or protected network, in communication with an external source or outside network 106, such as the Internet, via one or more communication lines 108. The network 104 and outside network 106 may each be of any variety of networks, such as corporate intranets, home networking environments, local area networks, and wide area networks, among others, and may include wired and/or wireless communication lines 108. Further, any of the known protocols, such as, for example, TCP/IP, NetBEUI, or HTTP, may be implemented to facilitate network communications.

The network 104 may include one or more devices 110 distributed throughout the network 104, as is well known in the art. Devices 110 may include computers, cell phones, personal digital assistants, printers, scanners, facsimile machines, servers, databases, and the like. Although specific examples are given, it should be appreciated that the network 104 may include any addressable device, system, router, gateway, subnetwork, or other similar device or structure. It should also be appreciated that, although specific and limited examples are given, the network 104 may be of any known topology and may include an unlimited number of devices 110.

The system 100 may also be used with security and/or monitoring software and devices 120. The security and/or monitoring software and devices 120 may be disposed on one or more of the devices 110 and/or communication lines 108 of the network 104 to monitor communications within the network 104 and/or between the network 104 and outside network 106. The security and/or monitoring software and devices 120 may include key logging software, spyware, antivirus software, firewall software, data loss prevention software, and other software that may be used to identify improper behavior within an organization and between the organization and others.

The security and/or monitoring software and devices 120 may communicate with the system 100 to indicate when a software or security policy is violated. More specifically, a software or security policy may be a keyword, format, sequence, and/or other search function that is actively or passively searched for by security and/or monitoring software and devices 120. In some circumstances, a software or security policy may represent a rule or communication standard observed by an organization. Consequently, a violation of a software or security policy may indicate that improper behavior has occurred within an organization and/or between the organization and others.

For example, an organization may have a rule that social security numbers are not communicated electronically. To enforce this rule, the organization may provide their security and/or monitoring software and devices 120 with a software or security policy that looks for any condition where nine numbers are found within eleven contiguous spaces. This software or security policy may generate a large number of false positives by determining that phone numbers provided in electronic communications are work tasks that require further review and potentially investigation. As used herein, work tasks include incidents that may be reviewed and potentially investigated.

Once the software or security policy is violated, the security and/or monitoring software and devices 120 may identify the violation as a work task, and more specifically, as an incident and send an incident notification to the system 100 for storage, review, and potentially investigation and follow-up by a security team, manager, human resource person, or other individual with the authority to operate the software within the organization. The incident notification may include a copy of the electronic communication and associated data and may be stored as information 124.

The security and/or monitoring software and devices 120 may scan all outgoing and/or incoming communications to detect an incident, such as a violation of a security policy. Monitored communications may include email (messages and/or attached documents), instant messages, web postings, file transfers, and voice over Internet. Other communication incidents may include, but are not limited to, incidents relating to email use, Internet use, document management, data transfer, and software use or compliance.

In some configurations, the system 100 may include security and/or monitoring software and devices 120 in order to directly detect an incident. The system 100 may include a processor 132, computer readable medium 134, and an output device 136. The output device 136 may be a display, a printer, a modem, a projector, a wireless communication card, or any other device capable of transmitting or communicating or providing an output of the system to a user or another system.

The computer readable medium 134 may store instructions 118 and the information 124. Alternatively, the instructions 118 and the information 124 may be stored in a separate database or device 110. The instructions 118 may be method provided in computer code that may be implemented by the processor 132 in order to provide prioritization of the review and investigation of the incidents identified by the security and/or monitoring software and devices 120 and other work tasks. Information 124 may also include software and/or security policies, information associated with incidents, and a history of reviewed incidents and related findings regarding each stored software and/or security policy.

The security and/or monitoring software and devices 120 may detect a large numbers of incidents per day. In order to more effectively allocate the limited resources of an organization, the instructions 118 may provide for automatically prioritizing each work task of a plurality of work tasks, including the review and investigation of detected incidents.

In some configurations, once a software or security policy is implemented, the instructions 118 may include the step of receiving an incident notification based on an incident associated with a violation of the security policy. Initially, the system 100 may prioritize each incident or work task resulting from the software policy on a first-in first-out or last-in first-out basis in order to determine a policy false positive rate for each of the policies implemented. The number of incidents reviewed and investigated on a first-in first-out or last-in first-out basis may be determined using well known statistical methods for a satisfactory confidence level, e.g. a 90% or 95% confidence level. More specifically, as each incident may be investigated and a determination made on whether the incident is a false positive. The information 124 may also include the determination. The false positive determinations may then be may be averaged to determine the policy false positive rate. For example, if one hundred incidents are reviewed and fifty-seven are determined to be false positives, the policy false positive rate 57%. The policy false positive rate may be updated as new false positive determinations are made as policy-related incidents are reviewed and investigated.

Alternatively, a default policy false positive rate may be initially provided for each new policy that is updated as each related false positive determination is made for that policy. For example, the default policy false positive rate may be 50% and having a weight of 100 decisions. The first incident reviewed may be determined to be a false positive. Consequently, the policy false positive rate would be updated to 50.5% or if calculated on a running average 51%.

The instructions 118 may include the step of determining a task false positive rate for each of the plurality of work tasks. In some configurations, the task false positive rate may be the policy false positive rate where only one policy has been violated. Where multiple policies have been violated, the lowest policy false positive rate associated with the work task or incident may be designated as the task false positive rate. Alternatively, the task false positive rate may be an average of the policy false positive rates associated with a work task.

The instructions 118 and method for work prioritization may also take into account other factors such as business risk, type of information, ease of investigation, legal responsibility to investigate a particular incident, time spent in the work queue, total number of policies violated in an incident, and number of incidents associated with a particular sender or recipient for a predetermined time period. For example, the instructions 118 may determine a risk value for each work task of the plurality of work tasks.

In one configuration, the risk value may be the total number of software and security policy violations in an incident. For example, an incident may have violated three policies with each policy being violated two, five, and seven times respectively. Consequently, the risk value would be fourteen. Alternatively, the risk value may be highest number of violations associated with a policy in an incident. Consequently in this example, the risk value would be fourteen.

In another configuration, the risk value may be one of a plurality of values that may be arbitrarily assigned to categories. For example, a risk value of one hundred may be assigned to a high risk category, fifty to medium risk, and ten for low risk. In this configuration, each software and security policy may identify incidents that may be categorized into one of these levels of risk. For example, if a policy is looking for social security numbers within email communications, the risk may be associated with the number of potential social security numbers found within an email. More specifically, an email with 1-5 social security numbers may be categorized as a low risk, while an email with 6-20 may be medium risk and anything greater than or equal to 21 social security numbers would be a high risk.

Alternatively, a monetary amount that may be lost in an actual violation of a software and security policy may be assigned. For example, potential loss of trade secret information related to a code word may result in a loss of $10,000 that would be assigned as the risk value for all incidents related to this policy.

In one configuration, an event materiality score (EM) may be determined for each incident using the factors of the risk value (R) associated with incident itself, and the task false positive rate (FPR) of the associated policy. This may be represented as the equation: EM=a(R)*b(1−FPR). The false positive rate may be subtracted from one to provide a higher score.

(a) and (b) may be arbitrary weighting factors that may be used to by the organization to emphasize one factor over the other. For example, the organization may believe that the risk factor is more important than the task false positive rate and hence, provide greater weight to the risk value factor (R).

Alternatively, (a) and (b) may represent other factors. For example, (a) may be the total number of software and security policies triggered and associated with a work task or incident, because the organization may believe that the more software and security policies that are violated, the more likely that a real violation has occurred.

Referring to FIG. 2, a configuration of a prioritized list 200 of work tasks 202 is illustrated. Once an event materiality score 204 has been determined for each work task 202, the work tasks may be prioritized and the prioritized list 200 provided to a user via an out put device 120. In this illustrated configuration, the first work task 206 or incident to be reviewed has the highest event materiality score 204 and may be placed at the top of the prioritized list 200 of work tasks 202. In other words, the event materiality score 204 may be used to prioritize new work tasks 202 so that available resources are first applied to those work tasks 202 that result from software and security policies with low false positive rates and high risk.

As shown, each work task 202 may be displayed with associated information 124, such as a priority number 210, an incident type 212, a risk value 214, the date and/or time 216 of the work task 202, a communication identification number 218, a triggering software and security policy identification number 220, an event materiality score 204, a current status 222 of the work task 202, a subject description 224 of the work task 202, a sender's information 226, and a recipient's information 228. The priority number 210 may be assigned once the work task 202 has been prioritized and provided for the investigation of the work task 202 to an output device 120. Although not shown, the work task 202 may also include the task false positive rate for each software and security policy, the weighting and range for the risk value, a resolution field for the reviewer and/or investigator to enter false positive determinations for each associated software and security policies, and other fields and information associated with the work task 202.

In some configurations, where a plurality of software and security have been triggered, the software and security policy identification number 220 and risk value producing the highest event materiality score 204 may only be displayed. Alternatively, all of the triggered software and security policy identification numbers 220 and associated risk values may be displayed for the work task 202. In yet another alternative, an aggregated event materiality score 204 may be used and displayed.

### INDUSTRIAL APPLICABILITY

In accordance with instructions 118 and method discussed above, a method and system for work prioritization is provided. Work prioritization may be effectively used to better allocate resources to the investigation of incidents that have a low false positive rate. Thus, an event materiality score for each policy may be determined and applied to incidents in order to more efficiently deploy investigatory resources where the value is greatest. It should be readily recognized that this work prioritization system and method may be applied to other applications such as research, customer service requests, search engines, and other applications where work prioritization is useful and false positive rates may be used to better allocate resources.

It will be apparent to those skilled in the art that various modifications and variations can be made without departing from the scope or spirit of the invention. Additionally, other embodiments of the invention will be apparent to those skilled in the art from consideration of the specification and practice of the invention disclosed herein. It is intended that the specification and examples be considered as exemplary only.

What is claimed is:

1. A method for prioritizing a work task within a plurality of work tasks, the method comprising:
determining a task false positive rate for the work task;
determining an event materiality score based on the task false positive rate; and
prioritizing the work task within the plurality of work tasks based on the event materiality score.

2. The method of claim 1, further comprising the step of determining a risk value for the work task, wherein the event materiality score is determined from the risk value.

3. The method of claim 2, wherein the risk value is based on a total number of violations associated with the work task.

4. The method of claim 1, wherein the work task includes an investigation of an incident notification triggered by a violation of a software policy.

5. The method of claim 4, wherein a policy false positive rate is associated with the software policy, wherein determining the task false positive rate is based on the policy false positive rate associated with the software policy.

6. The method of claim 4, wherein determining the event materiality score is also based on a total number of software policies triggered and associated with the work task.

7. The method of claim 1, further comprising providing a prioritized list of the plurality of work tasks.

8. A system for prioritizing a plurality of work tasks, the system comprising:
a computer readable medium storing instructions, the instructions including;
determining a task false positive rate for each of the plurality of work tasks;
determining a risk value for each of the plurality of work tasks;
determining an event materiality score for each of the plurality of work tasks based on the task false positive rate and the risk value; and
prioritizing the plurality of work tasks based on their event materiality scores;
a processor for implementing the instructions; and
an output device for providing a prioritized list of the plurality of work tasks.

9. The system of claim 8, wherein the instructions further include associating a policy false positive rate with each software policy, wherein determining the task false positive rate is based on the policy false positive rate associated with a violated software policy.

10. The system of claim 9, wherein for each work task, the task false positive rate is a lowest policy false positive rate associated with one or more violated software policies.

11. The system of claim 8, wherein each of the plurality of work tasks is triggered by a violation of a software policy.

12. The system of claim 11, wherein the risk value is based on a total number of violations associated with the software policy.

13. The system of claim 8, wherein the instructions further include providing the prioritized list of the plurality of work tasks to the output device.

14. The system of claim 8, wherein the event materiality score is determined by the risk value multiplied by a sum of one (1) minus the task false positive rate.

15. The system of claim 8, wherein determining the event materiality score is based on a total number of software policies triggered and associated with each work task.

16. A method for prioritizing an investigation of an incident, the method comprising:
implementing a security policy;
receiving an incident notification based on the incident associated with a violation of the security policy;
determining a policy false positive rate for the security policy;
determining a risk value for the incident notification;
determining an event materiality score for the incident notification based on the policy false positive rate and the risk value; and
prioritizing the investigation of the incident notification according to the event materiality score.

17. The method of claim 16, wherein the risk value is based on a total number of violations of the security policy.

18. The method of claim 16, wherein the risk value is one of a plurality of values, wherein each of the plurality of values is associated with one of a plurality of categories.

19. The method of claim 16, further comprising investigating the incident, determining whether the incident is a false positive, and updating the policy false positive rate based on the determination whether the incident is a false positive.

20. The method of claim 16, further comprising providing a priority number for the investigation of the incident to an output device.
